(19) United States
(12) Patent Application Publication
(10) Pub. No.: US 2020/0138051 A1
(43) Pub. Date: May 7, 2020

(54) GRAIN HUMIDIFICATION, STERILIZATION, COOLING, FREEZING AND DRYING TOWER

(71) Applicant: OTALÍCIO PACHECO DA CUNHA, São Leopoldo (BR)

(72) Inventor: OTALÍCIO PACHECO DA CUNHA, São Leopoldo (BR)

(21) Appl. No.: 16/338,407

(22) PCT Filed: Sep. 27, 2017
(86) PCT No.: PCT/BR2017/000117

§ 371 Date: Mar. 29, 2019

(30) Foreign Application Priority Data
Sep. 29, 2016 (BR) BR102016022709-7

(51) Int. Cl. A23B 9/02; A23B 9/08; A23B 9/10

(52) U.S. Cl. CPC A23B 9/025; A23V 2002/00; A23B 9/10; A23B 9/08

(57) ABSTRACT

A tower used to extend the life of the grains in the period of their storage, through procedures of grain humidification, sterilization, cooling, freezing and drying, which can be applied together or separately according to with the need of each particular cultivation, offering a multifunctional tower of high performance and low fuel & energy consumption, low noise and eco-friendly, not contaminating the grains that make the heat exchange with steam.

### BACKGROUND OF THE INVENTION

### Field of the Invention

This invention relates to a tower used to extend the life of the grains in storage silos by means of grain humidification, sterilization, cooling, freezing and drying procedures, which can be applied together or separately, according to the need of each particular cultivation.

### Brief Description of the Related Art

Pre-drying for further storage of grains, oilseeds and fodder is required to meet the % of w.b. (wet basis) required in order to preserve them and established by the market. As an example, we can mention the required percentages: sunflower seeds: 7% w.b., colza: 8% w.b., coffee: 12% w.b., corn: 14% w.b., wheat: 13% w.b. among others.

In order to guarantee the hygroscopic balance of the grains, their quality and durability, it is necessary to control the moisture and the possibility of contamination by fungi and the proliferation of insects, since, in general, the storage is aerobic, i.e. subject to attacks of fungi and insects, reducing the life of the grains.

Regarding the moisture content of the grains, excess moisture must be controlled, which greatly increases the proliferation of fungi and even the fermentation, and also the lack of moisture, which causes loss of product by weight, bringing economic losses.

Depending on the weather at harvest time, when hot and dry, grains are harvested with moisture content below recommended. As an example, we can mention soybeans, with a moisture content of 14% w.b., normally harvested at a content of 10% w.b., which represents an actual loss of 4.44%, resulting in the need to sell more dry material to replace what has been lost in water.

In addition, it should be mentioned that storage inside the silo, without any intervention of procedure and/or process, it is not possible to obtain standardization of grain moisture.

This problem of difficult hygroscopic grain balance, related to the ability of the grains to absorb and yield moisture and heat to the environment, results in significant losses in the sector.

Grain drying towers are known in the art, which aim to reduce the wet basis content of the grains stored in the silo.

These drying towers consist of heating the grains with hot air, causing the grains, when heating, to reduce moisture, reaching the wet basis values demanded by the market. However, the way of applying hot air does not guarantee homogeneity in the final result, generating temperature and moisture rates, providing still more the appearance of fungi and insects.

With respect to the subsequent maintenance of the grain temperature, in order to maintain the wet basis content reached in the drying tower and to avoid the proliferation of fungi and insects, grain cooling systems are known that act through the injection of cold air in the base of the silo, in order to cool the grains. It occurs that this method provides the concentration of impurities in the central and lateral part of the silos, and heating in several sectors of the stored grain mass. There are also systems of aeration and artificial cooling, with high implantation and energy consumption, remaining a loss of up to 10% of the grains stored by the problems already mentioned.

### SUMMARY OF THE INVENTION

This Grain Humidification, Sterilization, Cooling, Freezing and Drying Tower proposes a new technical effect, since it is based on the solution inventive concept of the existing problematic with respect to the state of the art of the object.

The tower in question has been developed so as to provide, in addition to the humidification and drying of the grains, the sterilization, cooling and freezing thereof, in order to maintain the wet basis content reached in the humidification step and render them immune to fungi and insects proliferation through cooling and/or freezing, greatly increasing their durability.

This objective is reached because the low temperature reduces the rate of respiration of the grains, avoiding fungus proliferation, efficiency loss, germination and burning of dry matter. The fact that the respiration rate of the grains is very low, that is, with negligible exchange of humidity and heat with the environment, added to its characteristic of self thermal insulation, also reduces the insect proliferation, ensuring, in the whole, the storage safe for at least 12 months, and a maximum of 5 years, depending on the grain, without the use of any chemical or natural.

Sterilization occurs through the application of dry steam at 300° C. along the tower, which is the only way to exterminate with the fungi from the crop, which, if they remain in the grains, will turn into aflatoxin. Aflatoxin is one of the main types of toxic substances produced by fungi during the action of food decomposition, which is highly harmful to health and even carcinogenic.

The moisture and temperature characteristics of the cooling and freezing of the grains should be appropriate according to the type of grain, oil or fodder, the region's weather and the necessary shelf life.

In order to do so, the tower described has multifunctional performance, which allows air circulation in various ways, according to the process to be performed. Coupled to the tower is the airflow treatment chamber, which contains the means of delivering saturated steam, dry steam preferably at 300° C., hot and wet air and refrigerated air.

For the grain humidification procedure, from saturated steam between 100° C. and 140° C., homogenizes the wet basis content in the appropriate value to the cultivation. The saturated steam is distributed throughout the tower, with all of the excess saturated vapor being redirected to the airflow treatment chamber through the vapor recovery tunnel, resulting in a closed airflow loop.

To perform sterilization, the air flow treatment chamber processes and distributes dry steam preferably at 300° C., which is distributed vertically along the tower, likewise recovering surplus by the vapor recovery tunnel. At this temperature, dry steam penetrates the beans and burns the eggs and larvae of live insects, as well as completely eliminates fungi producing aflatoxin. For this reason, this process is called sterilization.

In situations where the grain is harvested with moisture higher than the standard values, it is necessary to dry them. For grain to dry, the airflow treatment chamber treats and distributes air flow between 30° C. to 150° C., which is distributed vertically along the tower. The wet air is withdrawn from the interior of the tower by centrifugal fans positioned therealong and the existing airflow is completely recovered through the heat recovery tunnel, returning to the airflow treatment chamber, to condense the moisture extracted from the for heating, setting up a closed drying loop.

Grain cooling is the last stage of the process, and allows the storage of grain in optimal humidity at a temperature of 10° C. for up to 3 years. To this end, the airflow treatment chamber, through a cold radiator, treats the refrigerated air that is distributed along the tower in a stepwise manner, by sectors. This cold distribution scheduling is necessary so that the grains of the upper part of the tower, naturally at higher temperature, have gradual cooling, maintaining its characteristics. In cases where the temperature of the room is lower than the internal temperature of the tower, the upper register is opened for the exit of the hot air.

Thus, with a single set of equipment it is possible to perform the different procedures described for the conservation of the grains inside the tower, it being enough, for that, to choose the way of operation.

The application of this Grain Humidification, Sterilization, Cooling, Freezing and Drying Tower occurs in the use of this for storage of agricultural products.

This Grain Humidification, Sterilization, Cooling, Freezing and Drying Tower has the following advantages, with respect to the state of the art of the object in question:
It allows the correction of moisture content in the storage and dispatch of grains, oilseeds and fodder, according to each specific cultivation, avoiding losses in weight by evaporation of moisture or damages and losses due to excess moisture.
It enables the increase of the % of grain wet basis to reach market standards, through the wet steam humidification procedure;
It allows the reduction of the % of wet basis of the grains to reach the market standards, through the drying procedure;
It allows the sterilization of the grains in order to prevent the formation of aflatoxin, through the dry steam application procedure;
Allows the cooling of the grains to the temperature of 10° C. or less, through the refrigeration procedure, allowing its storage for 3 years or more, without the loss of its characteristics;
Prevents fungi infestation and insect proliferation, thus avoiding the disposal of grains;
It provides greater durability and maintenance of the quality of stored and dispatched grains, which means real gains to the producer;
Grain temperature control efficiency;
It provides consumers with better quality grains, particularly regarding the non-formation of aflatoxin, which is extremely harmful to health.

### BRIEF DESCRIPTION OF THE DRAWINGS

In order to facilitate the research and provide understanding of the present invention, as set forth in the report, according to a basic and preferred embodiment developed by the applicant, reference is made to the accompanying illustrations which form part of and support this descriptive report where:

FIG. 1—presents the tower containing airflow scheme in the grain humidification and sterilization process;

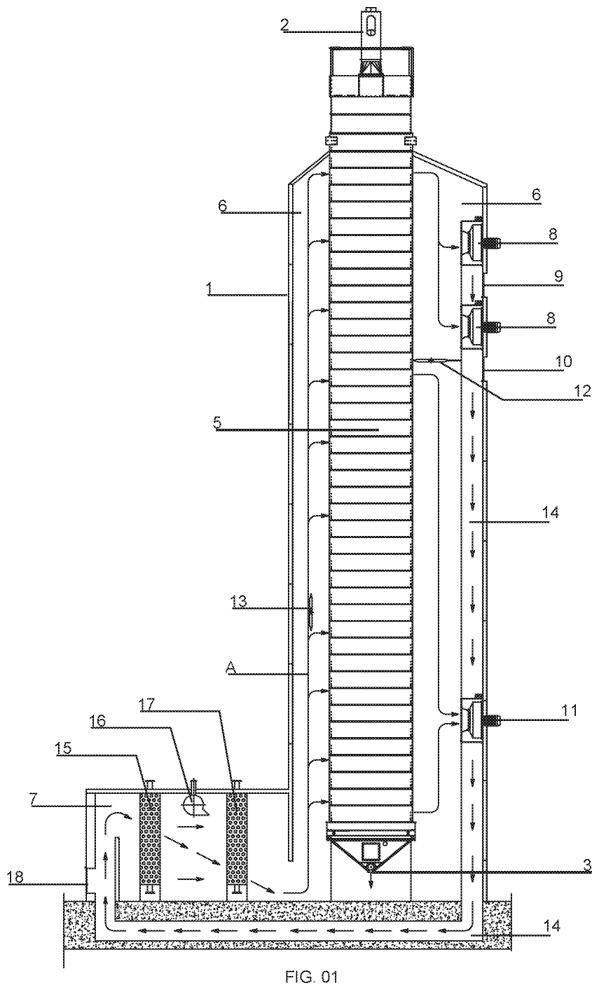

FIG. 2—presents the tower containing airflow scheme in the grain drying procedure;

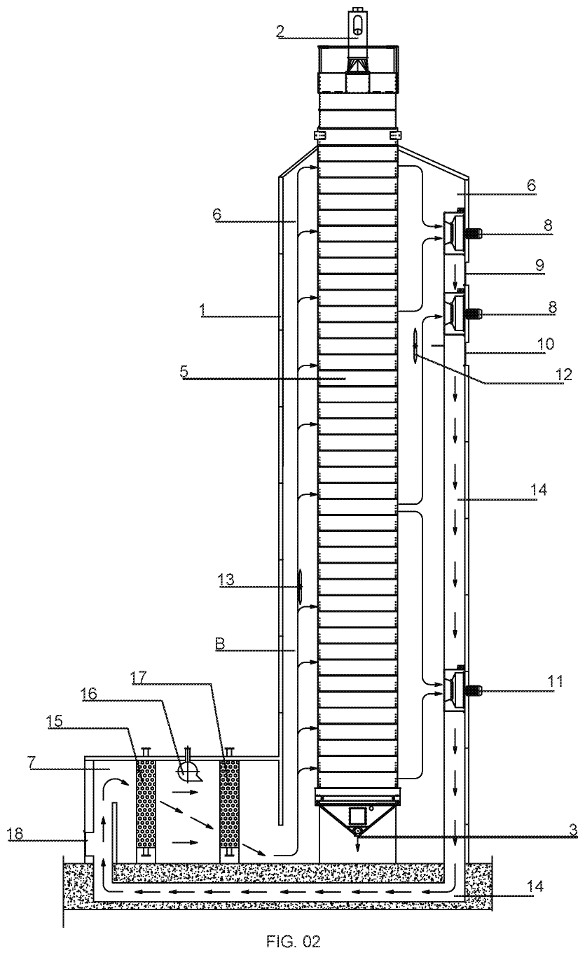

FIG. 3—presents the tower containing airflow scheme in the grain cooling procedure.

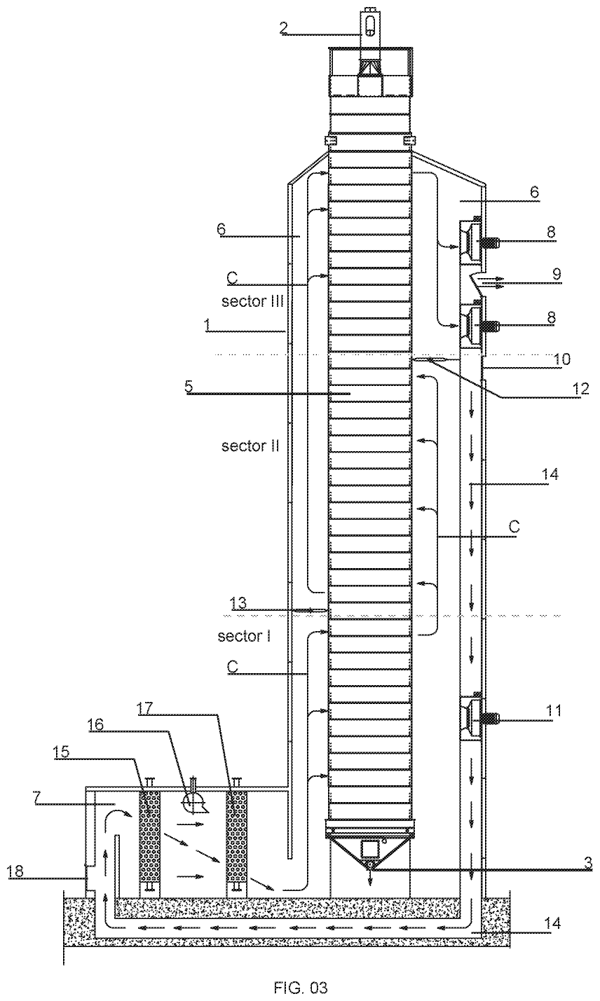

### DETAILED DESCRIPTION OF THE PREFERRED EMBODIMENTS

The Grain Humidification, Sterilization, Cooling, Freezing and Drying Tower is composed of the thermal tower (1) provided with an upper feed nozzle (2), through which grains from the harvest are placed, and the outlet nozzle (3) for unloading, in which grains of various types are delivered.

The location of the grains occurs in the inner grain chamber (5) around which is the air chamber (6) through which the air generated in the airflow treatment chamber (7) so that each procedure is performed.

In the air chamber (6) there are, on the upper side, two lines of centrifugal fans (8) interspersed by two lines of registers (9) and (10), and, below, a line of centrifugal fans (11). Inside the inner tube (6) there are the horizontal registers (12) and (13).

The air chamber (6) and the airflow treatment chamber (7) are interconnected by the recovery tunnel (14) so as to allow for continuous flow therebetween.

The airflow treatment chamber (7) comprises the cold radiator (15), the wet steam injector (16) and the heat radiator (17), which are actuated according to each procedure, as well as the register (18).

For the grain humidification procedure, the wet steam injector (16) injects moist steam at a temperature of 100° C. to 140° C., the register (18) of the airflow treatment chamber (7) being closed, in order to generate the wet airflow A, which travels through the air chamber (6), penetrating into the inner grain chamber (5). The register (12) must be closed, as well as the registers (9) and (10). The register (13) must be open to allow circulation of the airflow A and distribution of the moist vapor along the thermal tower 1.

The wet steam returns to the airflow treatment chamber (7) through the recovery tunnel (14), forming a closed circuit, since the centrifugal fans (8) and (11) are closed. In this way, the moisture that circulates between the grains allows the % of wet basis to be adequate to the standards. Optionally, the register (12) may be open and the register (13) closed or both open or both closed depending on the quantity of grains in the inner grain chamber (5).

In order for grain sterilization to take place, the same air flow A is injected by the wet steam injector (16) of the airflow treatment chamber (7), in which case the steam is dried, at a temperature between 280° C. and 320° C. Likewise, the register (12) must be closed, as well as the registers (9) and (10), the register (13) must be open. The excess dry steam returns to the airflow treatment chamber (7) by the recovery tunnel (14). Optionally, the register (12) may be open and the register (13) closed or both open or both closed depending on the quantity of grains in the inner grain chamber (5).

The grain closed-loop drying process occurs by the circulation of airflow B, whereby the ambient air recirculates in the airflow treatment chamber (7) by the closed register (18) and passes through the radiator cold (15). Registers (12) and (13) are opened so as to enable the free airflow into the air chamber (6). The wet air is withdrawn from the thermal tower (1) by the centrifugal fans (8) and the registers (9) and (10) which remain closed. The air from the flow B returns to the air flow treatment chamber (7) by the recovery tunnel (14), to condense the moisture extracted from the grain for further heating, forming a closed drying loop.

For the cooling of the grains and their stay at 10° C. or less and % of the standard basic moisture, the airflow C is treated and distributed by the cold radiator (15) of the airflow treatment chamber (7), and this air flow C is distributed in a stepwise manner in sectors I, II and III, passing the cold air first in the grains of sector I, followed by the others in the sequence. To do this, registers (10), (12) and (13) must be closed, as well as the centrifugal fans (8) and (11). The register (9) remains open with adjustment for the output of the hot air. The air in the flow C returns to the airflow treatment chamber (7) through the recovery tunnel (14).

Circulation of airflow C by sectors I, II and III occurs by closing the registers (12) and (13) from the interior of the air chamber (6), causing the grains to be gradually cooled from the bottom upwards, thereby providing the upper outlet of the remaining hot air.

In this way, the Grain Humidification, Sterilization, Cooling, Freezing and Drying Tower is subsidized by new technical and functional characteristics, as can be seen in the attached figures and understood in the descriptive report, thus deserving the legal protection sought.

1. A grain humidification, sterilization, cooling, freezing and drying tower, is composed of a thermal tower (1) provided with a feed nozzle (2) and an outlet nozzle, wherein the dynamic storage in the inner grain chamber (5) around which an air chamber (6) where it traverses the air generated in an airflow treatment chamber (7) containing a cold radiator (15), a steam injector (16), a heat radiator (17) and a register (18); the air chamber (6) comprises, at the top, two lines of centrifugal fans (8) intersected by lines of registers (9) and (10), and, below, a line of centrifugal fans (11); the inner air chamber (6) has horizontal registers (12) and (13); the air chamber (6) and the airflow treatment chamber (7) are interconnected by a recovery tunnel (14).

2. The grain humidification, sterilization, cooling, freezing and drying tower as claimed in claim 1, wherein the humidification procedure of the grains occurring by injection of the airflow A, moist steam, at a temperature between 100° C. and 140° C. by the moist steam injector (16), and the register (18) of the airflow treatment chamber (7), which runs through the air chamber (6) and penetrates the inner grain chamber (5), the register (12) being closed, as well as the registers (9) and (10); the register (13) must be open to allow circulation of the airflow A along the thermal tower (1); the centrifugal fans (8) and (11) must be closed; the moist steam returns to the airflow treatment chamber (7) through the recovery tunnel (14), forming a closed loop.

3. The grain humidification, sterilization, cooling, freezing and drying tower as claimed in claim 2, wherein, optionally, the register (12) is open and the register (13) is closed, or both the registers (12) and (13) closed, or both registers (12) and (13) opened, according to the amount of grains in the inner grain chamber (5).

4. The grain humidification, sterilization, cooling, freezing and drying tower as claimed in claim 1, wherein the grain sterilization procedure occurring by injecting the dry steam airflow A, at a temperature between 280° C. to 320° C., by the steam injector (16) of the airflow treatment chamber (7), which circulates in the air chamber (6) and penetrates the inner grain chamber (5), the register (12) must be closed, as well as the registers (9) and (10), the register (13) must be open; the dry steam returns to the airflow treatment chamber (7) through the recovery tunnel (14), forming a closed loop.

5. The grain humidification, sterilization, cooling, freezing and drying tower as claimed in claim 4, wherein, optionally, the register (12) is open and the register (13) is closed, or both the closed registers (12) and (13), or both the open registers (12) and (13), according to the amount of grains in the inner grain chamber (5).

6. The grain humidification, sterilization, cooling, freezing and drying tower as claimed in claim 1, wherein the closed-loop drying procedure of the grains occurring by circulating the airflow B in the air chamber (6) which penetrates the inner grain chamber (5), the air recirculating in the airflow treatment chamber register (7), the register (18) is closed and the air is passed through the cold radiator (15) to condense the water into steam, after passing through the heat radiator (17) to heat the air; the registers (12) and (13) must be opened; the moist air is withdrawn from the thermal tower (1) by the centrifugal fans (8) and (11) by the recovery tunnel (14), the recovery of the flow B returns to the airflow treatment chamber (7) by the recovery tunnel (14).

7. The grain humidification, sterilization, cooling, freezing and drying tower as claimed in claim 1, wherein the process of cooling the grains to a temperature of 10° C. or less by treating and distributing the airflow C through the cold radiator (15) of the airflow treatment chamber (7) with register (18) closed, that this airflow C is distributed staggered to sectors I, II and III of the air chamber (6) and penetrates the inner chamber (5), the registers (10), (12) and (13) must be closed, as well as the line of the centrifugal fans (8) and (11); register (9) remains open with regulation for hot air outlet; the air from the flow C returns to the airflow treatment chamber (7) by the recovery tunnel (14).
